(19) United States
(12) Patent Application Publication
(10) Pub. No.: US 2012/0065900 A1
(43) Pub. Date: Mar. 15, 2012

(54) LIFE MONITOR FOR ELECTRIC MACHINE

(75) Inventor: Michael D. Bradfield, Anderson, IN (US)

(73) Assignee: REMY TECHNOLOGIES, L.L.C., Pendleton, IN (US)

(21) Appl. No.: 12/881,360

(22) Filed: Sep. 14, 2010

(51) Int. Cl. G06F 19/00

(52) U.S. Cl. 702/34; 180/65.285

(57) ABSTRACT

A method for monitoring remaining life of an electric machine for a motor vehicle includes sensing a temperature of a component of the electric machine at one or more time intervals. A percentage of life of the component consumed at each time interval is calculated and the percentages of life consumed are summed to determine a total percentage of life consumed. The total percentage of life consumed is compared to a selected threshold. A life monitor system for an electric machine for a vehicle includes a temperature sensor secured to a component of the electric machine. An engine control unit is operably connected to the temperature sensor and is configured to calculate a remaining life of the component of the electric machine compared to a selected threshold, based on temperature data from the temperature sensor.

### BACKGROUND

The subject matter disclosed herein relates generally to electric machines. More specifically, the subject disclosure relates to life monitoring of electric machines of motor vehicles.

Electric machines for motor vehicles currently run in an open loop, meaning that an operator of the motor vehicle does not receive feedback regarding remaining useful life of the electric machine, or cumulative damage to the electric machine, until failure of the electric machine. With the increasing use of such electric machines in hybrid vehicles and electric vehicles, this is especially problematic if the motor fails at a location or position where a repair cannot be performed. For example, in a hybrid vehicle application including an internal combustion engine and an electric motor, the electric motor is often located inside of the transmission assembly of the powertrain. As such, repair of the electric motor is difficult and requires the vehicle to be diagnosed and/or repaired at a specialized repair facility. A mechanism that provides a notification or warning of cumulative damage or other condition in the electric machine which will lead to potential failure of the electric machine would be well received in the art.

### BRIEF DESCRIPTION

A method for monitoring remaining life of an electric machine for a motor vehicle includes sensing a temperature of a component of the electric machine at one or more time intervals. A percentage of life of the component consumed at each time interval is calculated and the percentages of life consumed are summed to determine a total percentage of life consumed. The total percentage of life consumed is compared to a predetermined threshold.

A life monitor system for an electric machine for a motor vehicle includes a temperature sensor secured to a component of the electric machine configured to sense a temperature of the component at one or more time intervals. An engine control unit is operably connected to the temperature sensor and is configured to calculate a remaining life of the component of the electric machine compared to a selected threshold, based on temperature data from the temperature sensor. A warning indicator is operably connected to the engine control unit and is configured to be activated when the remaining life of the component falls below the predetermined threshold.

A life monitor system for an electric machine of a vehicle having an internal combustion engine includes a temperature sensor secured to a component of the electric machine configured to sense a temperature of the component at one or more time intervals. An engine control unit is operably connected to the temperature sensor configured to calculate a remaining life of the component of the electric machine compared to a selected threshold, based on temperature data from the temperature sensor. A warning indicator is operably connected to the engine control unit and is configured to be activated when the remaining life of the component falls below the selected threshold.

### BRIEF DESCRIPTION OF THE DRAWINGS

FIG. 1 is a schematic life monitoring system of an electric machine for a motor vehicle; and

FIG. 2 is a cross-sectional view of a stator end turn of an electrical machine.

The detailed description explains embodiments of the invention, together with advantages and features, by way of example with reference to the drawings.

### DETAILED DESCRIPTION

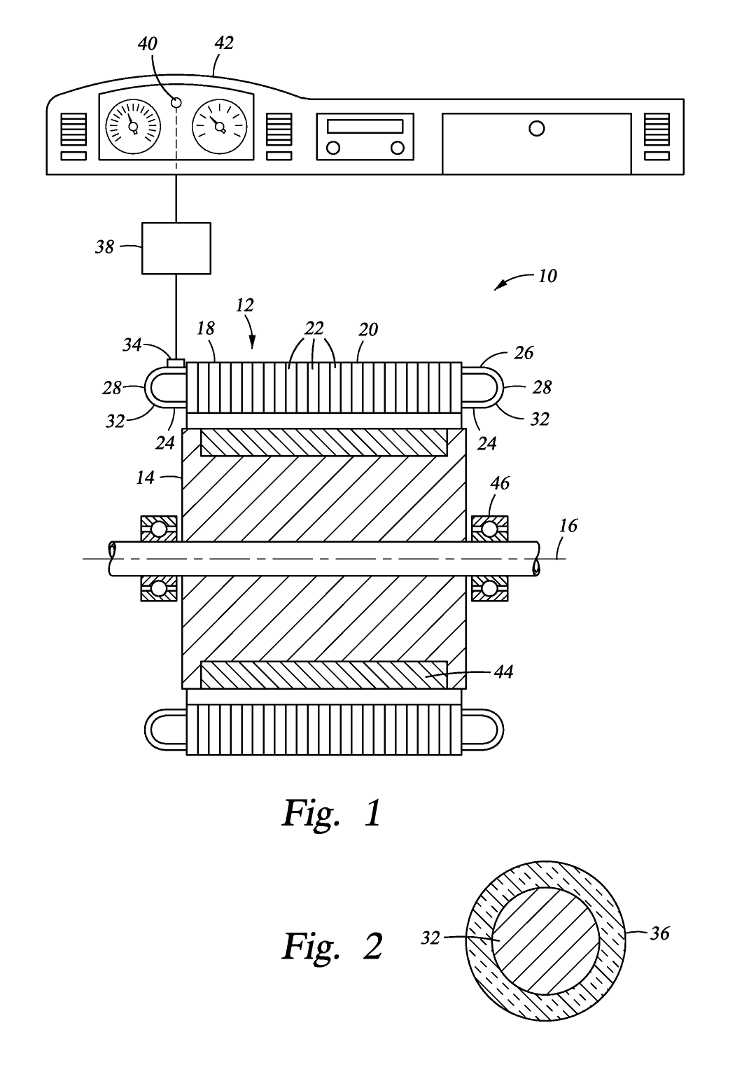

Shown in FIG. 1 is a schematic of a life monitoring system 10 for an electric machine 12. In some embodiments, the electric machine 12 is a motor for a hybrid vehicle or an electric vehicle, or other vehicle including an internal combustion engine working in combination with the electric motor to provide locomotive force for the vehicle. The electric machine 12 includes a rotor 14 rotatably secured about a central axis 16 of the electric machine 12. A stator 18 is located to be interactive with the rotor 14. The stator 18 includes stator core 20, which in some embodiments is formed from a plurality of stator laminations 22, and a plurality of conductors 24 extending through the stator core 20 forming a stator winding 26. At an axial end 28 of the stator 18, the conductors 24 form a plurality of end turns 32 where the conductors 24 exit the stator core 20, reverse direction, and reenter the stator core 20.

One or more temperature sensors, for example thermistors 34 are installed at the end turns 32. The resistance across each thermistor 34 is a function of the temperature of the end turns 32, specifically an insulation layer 36 (shown in FIG. 2) of the end turns 32. Further, the temperature of the insulation layer 36 is directly related to a life expectancy of the end turns 32 and thus the electric motor 12. For example, insulation layers 36 may be rated for an approximately 10,000 hour life operating at a temperature of 220 degrees Celsius or a life of 5,000 hours when operating at a temperature of 240 degrees Celsius. A life of the insulation layer 36 and the end turns 32 can be expressed as follows:

log L=C₁+C₂/(273+T)

Where L is the expected life of the insulation layer 36, C1 and C2 are constants based on the specific insulation layer 36, and T is the temperature of the insulation layer 36. Because the temperature of the insulation layer 36 may vary throughout operation of the electric machine 12, data is collected from the thermistors 34 at intervals of, for example, every ten seconds. A portion of life consumed during each particular interval is then expressed as:

% L=t/L_{T}

where % L is the amount of life consumed during a particular interval, t is the length of the interval, and L_{T} is the life of the insulation layer 36 at the temperature T. To determine life consumed over a number of intervals, the life consumed at each interval is summed:

% Lₜₒₜₐₗ=Σ % L

The thermistors 34 are electrically connected to an engine control unit of the vehicle, for example, a powertrain control module (PCM) 38. The PCM 38 monitors the resistance levels across the one or more thermistors 34, thus monitoring the temperature of the end turns 32. Further, the PCM 38 then calculates % Lₜₒₜₐₗ at each interval. When the % Lₜₒₜₐₗ reaches a threshold, for example, a percentage of life consumed which is selected by a user, the PCM 38 transmits a warning, for example, illuminating a light 40 at a dashboard display 42 of the vehicle. In some embodiments, the threshold is 90% of life consumed, but it is to be appreciated that 90% is merely exemplary and other thresholds are contemplated within the scope of the present disclosure. At this point, the operator of the vehicle has notice that a failure of the electric machine 12 is upcoming, and the electric machine 12 can be checked at a service facility prior to a field failure.

It is to be appreciated that while in the described embodiment the thermistors 34 are secured to and monitor the temperature of the end turns 32, the thermistors 34 could be applied to other components of the electric machine 12, for example, permanent magnets 44 of the rotor 14 or bearings 46.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for monitoring remaining life of an electric machine comprising:
sensing a temperature of a component of the electric machine at one or more time intervals;
calculating a percentage of life of the component consumed at one or more time intervals;
summing the percentages of life consumed to determine a total percentage of life consumed; and
comparing the total percentage of life consumed to a selected threshold.

2. The method of claim 1, further comprising transmitting a warning signal when the total percentage of life consumed exceeds the selected threshold.

3. The method of claim 2, wherein the warning signal is a light at a dashboard display of the motor vehicle.

4. The method of claim 1, wherein the component is end turn insulation of a stator of the electric machine.

5. The method of claim 1, wherein the temperature of the component is sensed via a thermistor.

6. The method of claim 1, wherein the calculating, the summing, and/or the comparing are accomplished via a powertrain control module.

7. The method of claim 1, wherein the time interval is ten seconds.

8. The method of claim 1, wherein the selected threshold is ninety percent.

9. A life monitor system for an electric machine comprising:
a temperature sensor secured to a component of the electric machine configured to sense a temperature of the component at one or more time intervals;
an engine control unit operably connected to the temperature sensor configured to calculate a remaining life of the component of the electric machine compared to a selected threshold, based on temperature data from the temperature sensor; and
a warning indicator operably connected to the engine control unit configured to be activated when the remaining life of the component falls below the selected threshold.

10. The life monitor system of claim 9, wherein the temperature sensor is a thermistor.

11. The life monitor system of claim 9, wherein the component is an end turn insulation of a stator of the electric machine.

12. The life monitor system of claim 9, wherein the warning indicator is a light at a dashboard display of the motor vehicle.

13. The life monitor system of claim 9, wherein the engine control unit is a powertrain control module electrically connected to the temperature sensor.

14. The life monitor system of claim 9, wherein the time interval is ten seconds.

15. The life monitor system of claim 9, wherein the selected threshold is ninety percent.

16. The life monitor system of claim 9, wherein the electric machine is a hybrid motor.

17. A life monitor system for an electric machine of a vehicle having an internal combustion engine comprising:
a temperature sensor secured to a component of the electric machine configured to sense a temperature of the component at one or more time intervals;
an engine control unit operably connected to the temperature sensor configured to calculate a remaining life of the component of the electric machine compared to a selected threshold, based on temperature data from the temperature sensor; and
a warning indicator operably connected to the engine control unit configured to be activated when the remaining life of the component falls below the selected threshold.

18. The life monitor system of claim 17, wherein the temperature sensor is a thermistor.

19. The life monitor system of claim 17, wherein the component is an end turn insulation of a stator of the electric machine.

20. The life monitor system of claim 17, wherein the warning indicator is a light at a dashboard display of the motor vehicle.

21. The life monitor system of claim 17, wherein the engine control unit is a powertrain control module electrically connected to the temperature sensor.

22. The life monitor system of claim 17, wherein the time interval is ten seconds.

23. The life monitor system of claim 17, wherein the selected threshold is ninety percent.
